(19) United States
(12) Patent Application Publication
(10) Pub. No.: US 2025/0362144 A1
(43) Pub. Date: Nov. 27, 2025

(54) SYSTEM FOR COORDINATING GEOGRAPHIC INFORMATION WITH VIRTUAL OBJECTS

(71) Applicant: Corepora, Inc., Palo Alto, CA (US)

(72) Inventor: Mitchell Daniel, Palo Alto, CA (US)

(21) Appl. No.: 18/669,975

(22) Filed: May 21, 2024

(51) Int. Cl. G01C 21/36; G06V 10/74; G06V 20/20

(52) U.S. Cl. CPC G01C 21/3632; G06V 10/761; G06V 20/20

(57) ABSTRACT

A method for visually displaying visual location indicators on a display of a device having a camera element, including determining position and orientation of the device, determining a geographic boundary based on position of the device, determining locations within the geographic boundary, determining objects proximate the device using the camera element, correlating objects proximate the device with locations within the geographic boundary, associating one visual location indicator with one location proximate the device, and displaying the one visual location indicator with the one location on the display of the device when the camera element is directed toward the one location.

### BACKGROUND

### I. Field

The present invention relates to the field of information management, and more specifically to coordinating geographic information with interactive virtual objects.

### II. Background

Navigation using GPS (Global Positioning System) data is well known. A system of satellites is used to determine position of an object on the earth, and such information can be conveyed to devices for purposes of navigation. Position of a user's device can be determined, the location of a desired destination may be known, and roads or other paths may be used to assist the user in navigating to the desired location.

However, such navigation and display on user devices typically offers a “bird's eye view” of the desired route, i.e., the roads to be travelled to reach the destination when travelling by automobile. An issue with this “bird's eye view” operation is that difficulties may arise when locations are obscure or difficult to find, such as a suite inside a large building, or when the user is taking a nontraditional path that has not been completely mapped. Additionally, issues arise when the position of the user not known with great precision, such as when the user is walking through an area and GPS tracking cannot determine the user's position, direction of travel, or speed with accuracy. In these situations, the device cannot offer the user accurate information about how to precisely navigate to the desired destination and the locations around the user.

Current smartphones include video capability and camera type functionality and automobiles are being provided with this type of video capability. However, the user cannot generally use these camera features to successfully navigate to a location when GPS tracking fails due to the aforementioned issues. A user may know she needs to head northeast but cannot locate the precise room she seeks and her smartphone or automobile camera cannot provide her with navigational assistance.

The issue of navigation can be thought of as one of information retrieval and usage. Previous methods of universal information retrieval and indexing rely on tasks such as web crawling as well as algorithms that provide information based on access to internet content. Web crawling and search algorithms result in a vast amount of relevant information in a single response to a search query's textual context and content. Such search methods predominantly employ text matching to determine information access, relevance, and retrieval, which are relatively slow and less than ideal.

The old methods limit access to useful information. Providing information based on keywords creates varying levels of information quality and utility due to the inefficiencies of its associated indexing, retrieval, and access techniques. These methods require constant web crawling and additional supporting techniques to determine if internet content is relevant enough to provide as information. This is ineffective and unsustainable compared to using real world coordinates with virtual access points and can limit access to information due to the overabundance of keywords. Consequently, keyword based indexing to provide web based information brings the disadvantages of limited precision, quality, real time access, and spatial awareness.

Prior navigation methods provided limited access to useful relevant information. Seeking and processing information based on keywords creates varying levels of information quality and utility due to the inefficiencies of indexing, retrieval, and access. Web crawling and search algorithms require constant operation and associated techniques to determine if internet content is both available and relevant enough to provide required useful information. Such operation can be ineffective and unsustainable and can limit access to information due to the overabundance of keywords. As a result, keyword based indexing to provide web based information brings the disadvantages of limited precision, quality, real time access, and geographical spatial awareness.

It would therefore be beneficial to provide enhanced navigation system that overcomes issues with prior designs.

### SUMMARY

The following presents a simplified summary in order to provide a basic understanding of some aspects of the claimed subject matter. This summary is not an extensive overview and is not intended to identify key/critical elements or to delineate the scope of the claimed subject matter. Its sole purpose is to present some concepts in a simplified form as a prelude to the more detailed description that is presented later.

According to one embodiment, there is provided a method for visually displaying visual location indicators on a display of a device having a camera element, comprising determining position and orientation of the device, determining a geographic boundary based on position of the device, determining locations within the geographic boundary, determining objects proximate the device using the camera element, correlating objects proximate the device with locations within the geographic boundary, associating one visual location indicator with one location proximate the device, and displaying the one visual location indicator with the one location on the display of the device when the camera element is directed toward the one location.

According to a second embodiment, there is provided a method for visually displaying visual location indicators on a display of a device having a camera element, comprising determining locations within a geographic boundary established based on position of the device, determining objects proximate the device using the camera element, correlating at least one object proximate the device determined using the camera element with at least one location within the geographic boundary, associating one visual location indicator with one location proximate the device, and displaying the one visual location indicator with the one location on the display of the device when the camera element is directed toward the one location.

According to a further embodiment, there is provided a method for displaying visual location indicators together with actual images on a display of a device having a camera element, the method comprising determining a location within a geographic boundary established based on physical position of the device correlating at least one object proximate the device determined using the camera element with at least one location within the geographic boundary, associating one visual location indicator with one location proximate the device, and displaying the one visual location indicator with the one location on the display of the device when the camera element is directed toward the one location.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 is a conceptual overview of elements of the present design;

FIG. 2 illustrates the device in operation as it appears to a user employing navigation functionality;

FIG. 3 is a representation of a scene having multiple locations and visual indicators provided on the display of the device in accordance with the present design;

FIG. 4 shows the representation of FIG. 3 when the device has been repositioned and information has been determined about a previously unknown location;

FIG. 5 is a flowchart of overall system flow; and

FIG. 6 shows mobile application flow.

### DETAILED DESCRIPTION

In this document, the words “embodiment,” “variant,” and similar expressions are used to refer to particular apparatus, process, or article of manufacture, and not necessarily to the same apparatus, process, or article of manufacture. Thus, “one embodiment” (or a similar expression) used in one place or context can refer to a particular apparatus, process, or article of manufacture; the same or a similar expression in a different place can refer to a different apparatus, process, or article of manufacture. The expression “alternative embodiment” and similar phrases are used to indicate one of a number of different possible embodiments. The number of possible embodiments is not necessarily limited to two or any other quantity.

The word “exemplary” is used herein to mean “serving as an example, instance, or illustration.” Any embodiment or variant described herein as “exemplary” is not necessarily to be construed as preferred or advantageous over other embodiments or variants. All of the embodiments and variants described in this description are exemplary embodiments and variants provided to enable persons skilled in the art to make or use the invention, and not to limit the scope of legal protection afforded the invention, which is defined by the claims and their equivalents.

Described embodiments are only some of the embodiments of the present invention, not all of them. If directional indications are provided (such as up, down, left, right, front, back, top, bottom, inner, outer, vertical, transverse, longitudinal, counterclockwise, clockwise, circumferential, radial, axial . . . ), the directional indication is only used to explain the relative positional relationship, movement conditions, etc. When the specific posture changes, the directional indication also changes accordingly.

A description related to “the first” or “the second” etc. in an embodiment are for descriptive purposes only and are not to be construed as indicating or implying their relative importance or implying the number of technical characteristics indicated. Thus, features defined as “first” and “second” may expressly or implicitly include up to one or more fewer features. In addition, the technical solutions of the various embodiments can be combined with each other.

The present design provides a visual navigating system that allows a user employing a computing device such as a smartphone to navigate using real world coordinates, such as GPS coordinates, and associated information. The system employs virtual objects to enhance navigational capabilities. The design provides universally accessible, interactive, and precise information relatively rapidly and effectively through advanced information indexing and access techniques. The present design spatially indexes information, such as location information, at relevant GPS coordinates, to make the location as well as guidance cues visually interactive and connected within a single information system. The system may employ, for example, a user device having a display that displays images in front of a lens or camera and navigational cues and/or information about locations being viewed in real time. Location information is searched and accessed using a device's spatial context in combination with visual input or information without specialized spatial computing and/or mixed reality hardware.

As used herein, the term “location” is intended to be interpreted broadly to mean any physical location on, for example, earth, that can be designated by mapping or geographic coordinates as well as any structure(s), feature(s), or item(s) or anything located at that geographic coordinate.

According to the present design, information may be accessed using a smartphone camera and the GPS location of the smartphone by conceptually connecting or associating the smartphone to the physical world instead of a digital location. The system indexes information for each desired GPS location, such as Room 317, SuperBrand Grocery Store, Miller's Woods, Locker 8023, etc. The system senses and displays physical proximity of locations in the real world. The system access functionality without the need for web crawling or traditional indexing resources and constraints. The system designates a central or base coordinate at the device location and searches for other known physical location coordinates near the device using software, camera, and/or sensors. For example, if the system is at a particular location identified by GPS sensing, the system will determine that three specific restaurants, two gas stations, six office buildings, and four retail stores are nearby based on known and readily available information. The system determines relevance of information found at other coordinates based on distance. Available and displayable information can be enhanced with additional search context. Continuing with the foregoing example, the system may determine physical locations readily known or easily available and may determine information such as street location, distance from the user and user device, and so forth from known available information, such as GPS coordinates of such locations. For example, gas station X is 800 yards from the user device and is at 12345 Main Street and is at GPS coordinate ABCDEFG. Once the desired information is determined, the system may display the relevant information to the user.

The user device may determine its orientation or direction it is facing and with information about current position may determine that the structure before it, across a street, is Office Building PQR. Alternately, the system may determine that based on its current position and direction, such as the direction the device is facing using gyroscopic or other directional determination functionality, that the building across the street is at GPS coordinate 11465790. The system may then display a type of indication of the identified structure, such as the name of the location, a relevant logo, or other visual indicator, at or near the location on the display of the device.

Such operation requires recognition or assessment functionality, specifically recognizing certain structures or features are buildings, streets, and so forth. GPS coordinate locations may be determined and relevant structures at that location may be recognized by the user device and visually labeled for display on the device. Further, the system may recognize and determine writing on buildings, for example, and/or may determine proximity to other known entities. As an example, the system may determine store X is next to the Dover Fish House, located at 9876 Fourth Street and thus may determine that Store X is the Staples store, known by the system to be located at 9874 Fourth Street.

Once the system accesses the information, such accessed information may be stored on the user device about the location identified, and the information may be matched or paired by the system either to the entity or the coordinate (e.g., the system may add a review to a restaurant, or may add an identifier to a room location at GPS coordinate 470281, such as “Bob Smith's Lab”). If unknown to the system, the system may establish or update the location for the user and/or for other devices or storage on a connected network. The system utilizes real world coordinates, APIs, and spatial awareness to improve indexing, retrieval, and access of information over the old methods of key words, web content, and text focused algorithms.

The present system locates and subsequently indexes information relevant to its current GPS coordinate. The system may, in one embodiment, determine and display information and/or graphical representations on the user device of the coordinate and known information about the location in the real world. The system may then provide access, or information regarding, the coordinate and information determined about an entity or location at that coordinate through proximity, a camera, and/or digital searching. The system may call or retrieve known data for that location upon request.

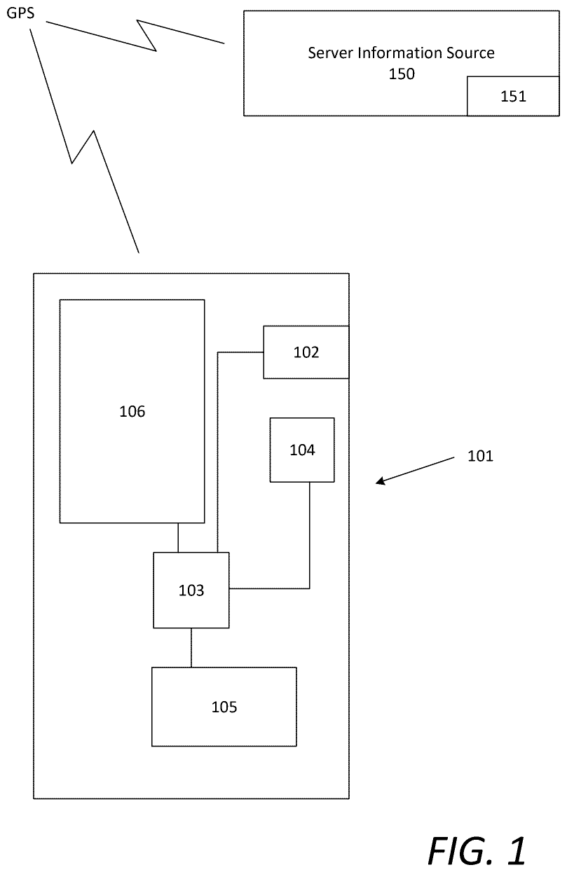

FIG. 1 is an overview of the components of the present system. From FIG. 1, device 101 includes lens/camera 102 and includes a processor 103 and transmitter 104. Local storage unit 105 is also provided and display 106 allows for the display of information. Lens/camera 102 is connected to processor 103, and processor 103 is connected to all other components of device 101.

In operation, a GPS transmitter communicates a signal and orbit data that enables device 101 to decode the information and compute satellite position. Device 101 uses this information and calculates position using triangulation, specifically determining the position or location of the device 101 on Earth. The user may select the current function, namely navigation according to the current design, causing the lens/camera 102 and processor 103 to assess device location, begin collecting images, and commence determining entities or establishments in an identified region. Once visual information is being collected and location of the device is determined, the system may identify known entity locations in the region. If none are available, such as the device being on a path in the woods, in the desert, or at sea, processor 103 may determine the direction the device lens/camera 102 is pointing using available functionality such as gyroscopic functionality and may correlate that orientation and known location with known locations, establishments, entities, etc. near the device or in front of the device knowing position and orientation.

If no or limited information is available, the device may seek information from information source 150, which may be the cloud, an arrangement of servers, or other accessible service or hardware. Storage element 151 may include and provide information about known geography, geographic features, navigation data such as GPS data of certain locations, and information related to known places, locations, businesses, residences, and so forth.

Device 101 including processor 103 generally transmits current location and in some embodiments a region, such as a half mile circle around current position, to information source 151 seeking all known information in the limited area. The information source transmits known information to device 101. At this point, device 101 may enable visual functionality, providing cues, graphics, logos, text, and/or other relevant information to the user via display 106. Alternately, if no significant information is found, or less information than desired is found, the system and the device 101 may seek additional information from information source 150 and/or other available devices or services and searching and determining locations may be ongoing.

For example, if the system determines Fred's Bait Shop is less than half a mile away in a southwesterly direction, and device 101 is pointing north, the system may seek information about entities, locations, or areas north of the user based on current position and the northward direction where device 101 is directed. Device 101 may view a street, may have information about the street, and may seek structures or locations along the street. If the device finds a warehouse, the device may seek information about a warehouse on Washington Avenue. If the specific warehouse is identified, information about the warehouse may be provided if available, such as reviews, hours of operation, phone number, exact address, and so forth.

The user may be moving her device, including moving in a circle, taking device 101 at arm's length around in a circular manner. In this instance, any available information determined, such as structures, streets, natural features, and so forth, when perceived and determined by device 101, may result in such information being employed for navigation purposes, with the associated local and remote searching described above.

Should the user select navigation functionality, the system may take the known information in the zone or region determined and may determine an appropriate graphic, indication, indicator, or other visual representation. The system may display that visual representation on display 106. For example, if device 101 determines that it is on Walker Street and determines, by visual processing of images received via lens/camera 102 or by position such as GPS coordinate(s), that the structure across the street is a Walmart store, it may display a Walmart logo or the word “Walmart” on the structure on display 106 of device 101. If the user is navigating to Room 203 at the University of Alabama English building, processor 103 may determine and display 106 may display a route to that building and/or the room if possible. The system superimposes such graphics on the structure or location by displaying both the graphic and the street, location, area, etc. on display 106.

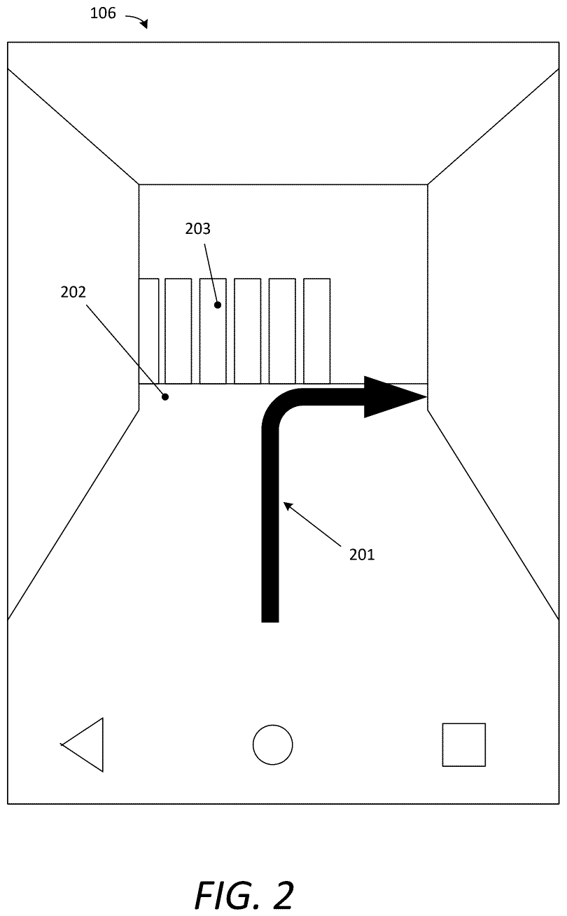

FIG. 2 conceptually illustrates a user screen when using the system and design provided herein. From FIG. 2, the user is navigating to Locker 118 at Springfield High School. The system has information about the floor plan of the school and determines the desired path to the locker. The system places arrow or indicator 201 showing the user the direction of travel, which includes going down aisle 202. Other lockers such as locker 203 are shown in this view.

Navigation may take into account known streets, pathways, and other avenues getting the user from a point of origin to the destination. Navigation in this manner is generally understood and is available on, for example, many modern automobiles, but is primarily limited to two dimensional over a known map. The system may determine perspective when superimposing a desired route when a device such as a smartphone is being used. Other indicators may be provided to indicate a suggested route, such as simple arrows.

In the case of an automobile, the system may superimpose the directions on the windshield or may provide directions via a display on the dashboard. Any system that uses a computing device for display of a navigation route, typically employed with geographic coordinate systems such as GPS, may employ the current design. The design is not, for example, limited to the representation presented in FIG. 1.

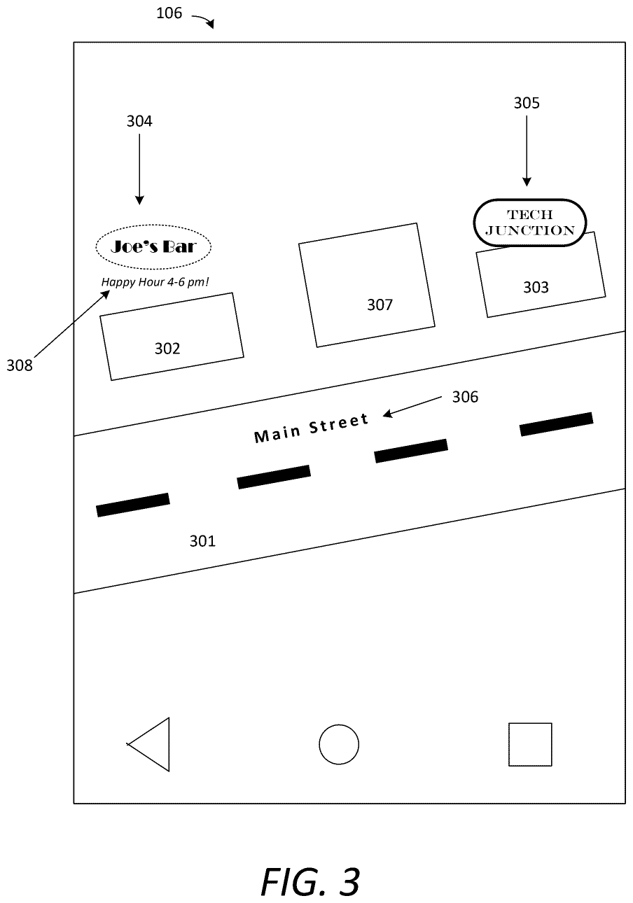

FIG. 3 is an alternate user screen representation. In FIG. 3, display 106 shows street 301 and structures 302, 303, and 307. Logo 304 is superimposed over structure 302 while label 305 is provided above structure 303. No information is currently available about structure 307, and thus no information or indicator is provided above or on structure 307. The system may be assessing and/or processing in the background, and in one embodiment if the system determines relevant information, the system may display the newly located information above or on structure 307. Label 306, the name of the street, is provided on street 301. Additional text associated with structure 302 is provided, and may be displayed with the logo or other information, with an appropriate subscription or payment, or in any other manner desired.

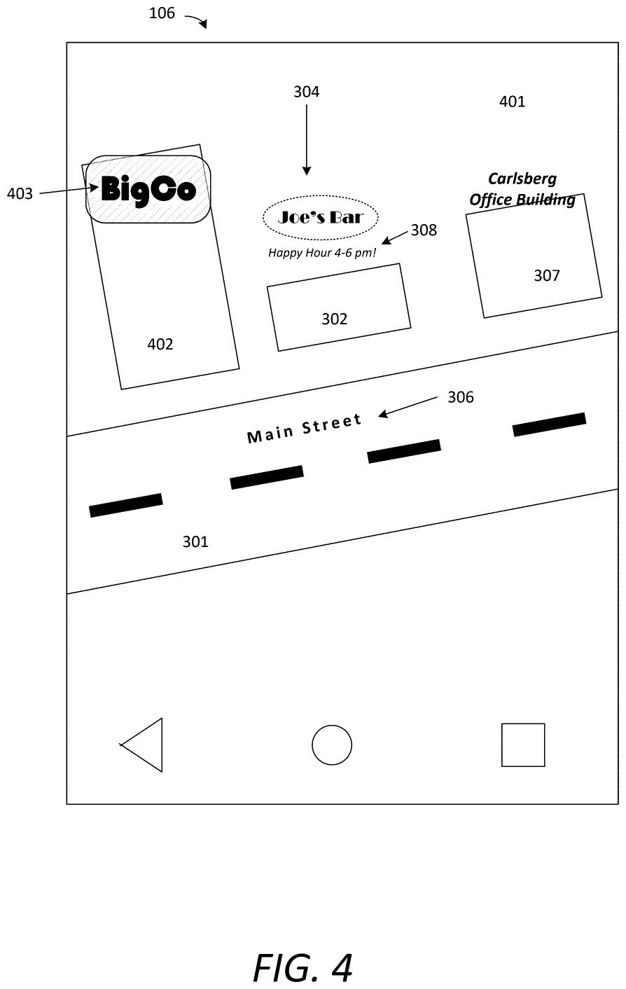

FIG. 4 is a further view of the street of FIG. 3 where the user has rotated device 101. From FIG. 4, structure 307 now has indicator 401, structure 302 again has logo or indicator 304, and structure 402 is shown with a name 403 superimposed on top of structure 402. Anything determined and relevant may be displayed above or on a location, as determined by the device 101, information source 150, by available information, or based on the desire of persons or entities associated with the establishment.

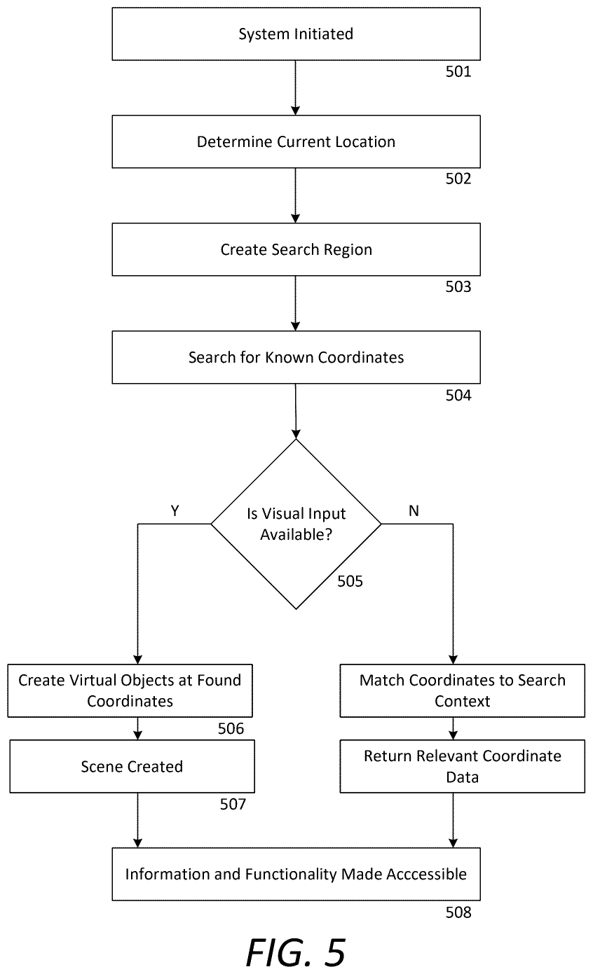

FIG. 5 illustrates overall system functionality. From FIG. 5, the system initiates operation at point 502 wherein a button push or other instantiation occurs. Operation using device 101, including employing the lens/camera begins. At point 502, if not already known, the system determines the current location, such as in GPS or other geographic coordinates. At point 503 the system establishes a search region, such as a circular distance around the location of the device. Different search regions may be established in certain situations. For example, if the device is at a beach location, the system may not search the nearby ocean. The system creates a boundary around the search region. Point 504 calls for searching for known coordinates. In one instance, the system determines known structures within the boundary area established at point 503. The system may seek additional information from a remote source such as information service 150, which may have information about locations within the boundary area unknown by device 101. Additionally, information available to device 101 may be provided to a remote source such as information service 150, enabling other users to benefit from the information. Thus point 504 calls for checking available coordinate data within the boundary to identify locations.

Point 505 determines whether the user will employ visual input from lens/camera 102 on device 101. The user may be presented with an option to employ or not employ lens/camera 102. If the user employs visual input, point 506 calls for creating virtual objects at found coordinates. Again, with knowledge of current position, device orientation, and locations within the region, the system may determine particular locations. The particular locations may have information associated therewith, such as name, a logo, information such as hours of operation, street address, telephone number, web site, and so forth. A hierarchy of display may be provided, such as logos first, with or without any other information, with text being the default.

At point 507, the system may provide representations to the display, including a visual representation of the scene in front of lens/camera 102 such as those shown in FIGS. 2 through 4. With these actual received visuals, the system may determine position of the locations and may superimpose graphics on or near the actual locations. As an example, if the device is facing east and the user is at GPS coordinate XYZ, they system may receive a visual representation of a building known to be a processing plant and may attach the name “My City Processing Plant” to the location. The system may correlate the presence of a building, determined by processing the visual received to indicate a building structure, with known buildings that are east of the device, for example providing the text “My City Processing Plant” to be displayed in proximity to the building when the user is facing east. The system offers the visual representation, such as the foregoing text, via the display to the user.

When the user moves the device, such movement is sensed at the device, again by for example gyroscopic functionality, and the device and lens/camera may be facing away from the location. The device determines that the location is not viewable and thus does not superimpose or provide the graphic when the structure is not in view as determined by processor 103.

The system may establish the GPS coordinate of the location or feature, such as at GPS coordinate PQR, known to be east of the device at GPS coordinate XYZ, and when the device is pointed east the device displays the visual representation at that coordinate.

Point 508 causes the information and functionality to be made accessible. Information determined may be provided to a remote location or the cloud, such as information service 350. Information may be provided by the user. For example, if the location is a structure that houses a business, the user may indicate the hours of operation she determines for the business, or may indicate the business has permanently closed. Such information may be subject to verification. Specific features may be indicated, such as Room 108 being Jennifer's office.

Point 508 provides for point-to-point navigation, wherein a path to a desired location is determined based on available data regarding roads, paths, and so forth, wherein the path is marked by lines or arrows or other indicators of direction of travel. Such directions may be found in various ways. For example, guidance over roads, through hallways, and so forth may be accomplished by determining the current position and destination point using geographic coordinates, determining a best route based on available information, and determining viable passageways, roads, or other paths to the desired destination. The route selected to the destination includes areas having geographical coordinates, and the system provides display for the route based on these geographical coordinates. For example, when taking roadway X, the system determines or has information about geographic coordinates of roadway X, and can thus display guidance cues, such as arrows or pathways or other indicators along that roadway. The system may then display a guidance path on device 101 and may maintain display of that guidance path when the user tilts, moves, or rotates device 101 as applicable. The guidance indication would cease displaying when device 101 and lens/camera 102 points away from the route.

From FIG. 5, if visual input is not available or being employed at point 505, the system matches coordinates to search content, collecting data based on the search request without use of lens/camera 102. The system determines the route in question based upon available local and information acquired from remote locations to plan out and display to the user, such as in two dimensional map form. The region searched is based on the search region established at point 503. Point 510 returns relevant coordinate data, such as geographic coordinate data, and presents the information via display 106 as text, on a two dimensional map, or as desired. Information may include logos or information about the desired location and/or locations in the search region. Again, when visual input is not employed, point 508 calls for making information and functionality accessible, including providing point to point navigation, using functionality for the location such as displaying relevant information, and so forth.

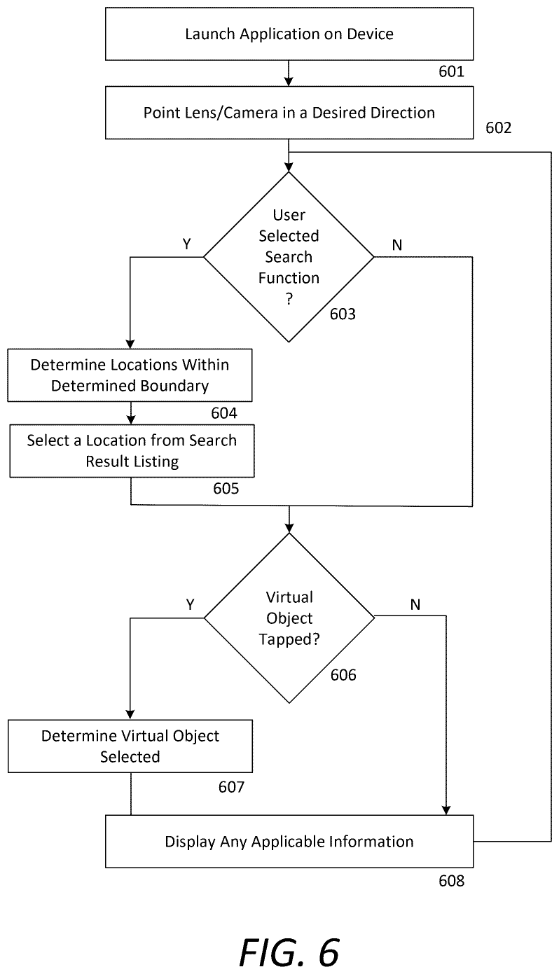

FIG. 6 illustrates device flow. From FIG. 6, device 101 initiates processing of the present functionality at point 601. At point 602, the user directs lens/camera 102 of device 101 in the direction of the desired route or feature. Device 101 displays the image with, when available, navigation indications and/or other relevant information, including but not limited to logos, text, and so forth. Point 603 determines whether the function has been selected, such as pressing a button or otherwise instantiating the function. If the user has selected the search function on device 101, point 604 calls for device 101 to collect nearby coordinate data, specifically geographic coordinates of locations, passageways, structures, geographic features, and so forth from information available on the device and information available remotely within the selected search region. At point 605, in one embodiment, device 101 displays nearby locations in either a graphical view or a list view, and the user can select a location from the search result list or graphical view. The user may also navigate to a desired location.

Virtual objects such as logos, text, or other relevant information about a location may be displayed proximate their location on display 106 and the user may select the virtual object to receive further information. Point 606 determines whether a tap of a virtual object has occurred. If so, point 607 determines the virtual object selected. At point 608, device 101 displays the information on display 106. Operation continues looping through awaiting a further search query or selection of a logo, for example, or until the function is deselected by the user.

Thus according to the present design, the system and device 101 may launch functionality on device 101. The system initially obtains device location, creates a selected region around the device location thereby establishing a geographical search region, and continuously searches for known locations, either searching locally or from remote sources, within the selected region to determine coordinates or other geographic positional attributes or values of proximate locations. If the system determines location within the selected region, the system determines the distance and creates an object, such as an augmented reality or visually representable element at the location's coordinate including an associated graphic or textual indicator. Device position and orientation is continuously updated.

The object rendered on the user's device may be selected, such as a logo provided when the device and the lens/camera is directed at the location, and when selected on the device and the indicator (logo, text, or otherwise) is displayed on device 101. In one embodiment, the system may obtains the coordinates and identifier of the location. The system may then obtain the associated information and may display relevant information, such as type of location, operating hours, web site, contact information, and so forth.

If the user selects a search function, the system obtains device location, searches the selected search region for locations, which may be limited to types of locations (restaurants, libraries, clothing stores, etc.) from known coordinate data for such locations, and displays search results. In one embodiment, device 101 may display results in a list or alternately on a two dimensional map.

According to the present design, the system determines the location coordinate of device 101 and checks for known coordinates in the determined region. The system then determines orientation, such as using a compass or gyroscopic function, to determine if device 101 is facing toward a coordinate's latitude and longitude. The system then displays a virtual object on the interface, such as display 106 at a desired position (altitude and scale) based on distance from the location. Virtual objects may rotate to appear to be facing device 101 regardless of viewing angle or orientation relative to the object.

Based on location of device 101 and the region (e.g., PQR Grocery on 35^{th} Street, plus an X meter radius), orientation of device 101 (e.g. south-southwest), and region known coordinates (knowledge of the south wall and north wall coordinates at PQR Grocery) such as GPS coordinates and/or longitude and latitude, the south wall is in front of device 101 you and the north wall is behind device 101. Objects display as the lens/camera 102 points in the direction of the known coordinate of the location. The system determines the visual object or indication displayed based on data for the known coordinate (e.g., the PQR Grocery logo).

In a further embodiment, the present design may collect signals, such as Bluetooth or EMF signals using, for example, BLE beacons or IoT system transmissions. Such signals which may be interpreted and determined to originate from a location and may employ triangulation or other techniques to determine the location from where the signal originates. For example, if the system receives a Bluetooth transmission known to be transmitted from Mike's Auto Repair, knowing where device 101 is located may enable the system to identify Mike's Auto Repair and display information relating thereto via the device.

In one embodiment, BLE Beacons such as Estimote UWB beacon or IoT systems may be employed. The system may be configured to detect such signals based on proximity. A beacon may, for example, be provided in a business configured with an identifier or information related to that location that is transmitted continuously without encryption. The beacon may also transmit a unique app ID and/or information about its coordinate location and pass that coordinate location to the system using Bluetooth or other appropriate transmission. The system would display on device 101 information/functionality related to beacon location as if spatially searching using geographic coordinates.

If desired and selected, the system may perform a navigation function, collecting coordinates of the destination and plotting or determining a path to the location. The system may establish a desired path and may provide a visual navigational path on the device when the device is pointed in the direction of the determined path, such as along roads, up stairs, and so forth, when information about the path is known and data available.

Thus according to one embodiment, there is provided a method for visually displaying visual location indicators on a display of a device having a camera element, comprising determining position and orientation of the device, determining a geographic boundary based on position of the device, determining locations within the geographic boundary, determining objects proximate the device using the camera element, correlating objects proximate the device with locations within the geographic boundary, associating one visual location indicator with one location proximate the device, and displaying the one visual location indicator with the one location on the display of the device when the camera element is directed toward the one location.

According to a second embodiment, there is provided a method for visually displaying visual location indicators on a display of a device having a camera element, comprising determining locations within a geographic boundary established based on position of the device, determining objects proximate the device using the camera element, correlating at least one object proximate the device determined using the camera element with at least one location within the geographic boundary, associating one visual location indicator with one location proximate the device, and displaying the one visual location indicator with the one location on the display of the device when the camera element is directed toward the one location.

According to a further embodiment, there is provided a method for displaying visual location indicators together with actual images on a display of a device having a camera element, the method comprising determining a location within a geographic boundary established based on physical position of the device correlating at least one object proximate the device determined using the camera element with at least one location within the geographic boundary, associating one visual location indicator with one location proximate the device, and displaying the one visual location indicator with the one location on the display of the device when the camera element is directed toward the one location.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A method for visually displaying visual location indicators on a display of a device having a camera element, comprising:
determining position and orientation of the device;
determining a geographic boundary based on position of the device;
determining locations within the geographic boundary;
determining objects proximate the device using the camera element;
correlating objects proximate the device with locations within the geographic boundary;
associating one visual location indicator with one location proximate the device; and
displaying the one visual location indicator with the one location on the display of the device when the camera element is directed toward the one location.

2. The method of claim 1, further comprising:
determining a desired travel path from the position of the device to a desired location; and
visually representing the desired travel path to the desired location on the display of the device when the camera element is directed toward the desired travel path.

3. The method of claim 1, further comprising associating additional graphically displayable and displayed information with the one location.

4. The method of claim 1, wherein determining locations within the geographic boundary comprises seeking information from a source remote from the device.

5. The method of claim 1, wherein the correlating, associating, and displaying are ongoing wherein new locations correlated are each displayed with an associated visual indicator when identified.

6. The method of claim 1, wherein the position of the device, geographic boundary, and locations within the geographic boundary are determined using the Global Positioning System (GPS) information.

7. The method of claim 1, wherein the device comprises one of a smartphone, automobile, tablet device, and smart watch.

8. A method for visually displaying visual location indicators on a display of a device having a camera element, comprising:
determining locations within a geographic boundary established based on position of the device;
determining objects proximate the device using the camera element;
correlating at least one object proximate the device determined using the camera element with at least one location within the geographic boundary;
associating one visual location indicator with one location proximate the device; and
displaying the one visual location indicator with the one location on the display of the device when the camera element is directed toward the one location.

9. The method of claim 8, further comprising:
determining a desired travel path from the position of the device to a desired location; and
visually representing the desired travel path to the desired location on the display of the device when the camera element is directed toward the desired travel path.

10. The method of claim 8, further comprising associating additional graphically displayable and displayed information with the one location.

11. The method of claim 8, wherein determining locations within the geographic boundary comprises seeking information from a source remote from the device.

12. The method of claim 8, wherein the correlating, associating, and displaying are ongoing wherein new locations correlated are each displayed with an associated visual indicator when identified.

13. The method of claim 8, wherein the position of the device, geographic boundary, and locations within the geographic boundary are determined using the Global Positioning System (GPS) information.

14. The method of claim 8, wherein the device comprises one of a smartphone, automobile, tablet device, and smart watch.

15. A method for displaying visual location indicators together with actual images on a display of a device having a camera element, the method comprising:
determining a location within a geographic boundary established based on physical position of the device;
correlating at least one object proximate the device determined using the camera element with at least one location within the geographic boundary;
associating one visual location indicator with one location proximate the device; and
displaying the one visual location indicator with the one location on the display of the device when the camera element is directed toward the one location.

16. The method of claim 15, further comprising:
determining a desired travel path from the position of the device to a desired location; and
visually representing the desired travel path to the desired location on the display of the device when the camera element is directed toward the desired travel path.

17. The method of claim 15, further comprising associating additional graphically displayable and displayed information with the one location.

18. The method of claim 15, wherein determining locations within the geographic boundary comprises seeking information from a source remote from the device.

19. The method of claim 15, wherein the correlating, associating, and displaying are ongoing wherein new locations correlated are each displayed with an associated visual indicator when identified.

20. The method of claim 15, wherein the position of the device, geographic boundary, and locations within the geographic boundary are determined using the Global Positioning System (GPS) information.

21. The method of claim 15, wherein the device comprises one of a smartphone, automobile, tablet device, and smart watch.
